(19) United States
(12) Patent Application Publication
(10) Pub. No.: US 2006/0179010 A1
(43) Pub. Date: Aug. 10, 2006

(54) Arbitration method

(76) Inventor: Michael C. Knecht, Palm Beach Gardens, FL (US)

Correspondence Address: MCHALE & SLAVIN, P.A., 2855 PGA BLVD, PALM BEACH GARDENS, FL, 33410, US

(21) Appl. No.: 11/095,964

(22) Filed: Mar. 30, 2005

Related U.S. Application Data
(63) Continuation-in-part of application No. 11/054,917, filed on Feb. 9, 2005.

(51) Int. Cl. G06Q 99/00; H04L 9/00; H04K 1/00

(52) U.S. Cl. 705/80; 705/1

(57) ABSTRACT

Instead of the traditional arbitration panel of three (3) lawyers deciding an aggrieved party's liability and damage claims, the present method subjects at least the liability claims to at least one arbitration panel of at least three (3) qualified experts in the field of endeavor applicable to the dispute. If liability is determined, then damages can be determined.

### CROSS REFERENCE TO RELATED APPLICATIONS

This invention is a continuation-in-part of the applicant's co-pending application Ser. No. 11/054,917 filed Feb. 9, 2005, the contents of which are hereby incorporated by reference in their entirety.

### FIELD OF THE INVENTION

This invention relates to the field of alternative conflict resolution (ACR), in particular, to a process for arbitrating a dispute in a specified field of endeavor between opposing parties and, more particularly, to such an arbitration process for use in fields of endeavor where the knowledge of an expert in the field can be dispositive, or at least influential, in deciding the corresponding issues of liability.

### BACKGROUND OF THE INVENTION

Mediation and arbitration processes are increasingly used to settle conflicts between potential litigants, saving time and money. Arbitration normally awards the arbitrator the power to decide the substantive questions and issue a decision to which the parties are bound. Mediation is an attempt to negotiate until the parties reach some kind of a consensus on the issues.

To facilitate the arbitration or mediation process, the parties commonly enter into preliminary agreements as to the “metes and bounds” that the procedure will include such as: the qualifications of the arbitrators/mediators, how the arbitrators/mediators are selected, where proceedings will be held, what issues are appealable, and so forth.

In medical malpractice cases, for example, the standard arbitration technique usually has three arbitrators who are lawyers and experts in the field. One lawyer is chosen by each side and they choose a third lawyer to complete the panel. This panel then decides all issues of liability and damages.

Despite the possible cost savings available through the use of arbitration, disputes such as medical malpractice continue to be a highly litigated area making it a very serious concern for doctors, medical providers, insurers, patients and the public, in general. For example, U.S. Pat. No. 5,875,431 to Heckman et al, filed Mar. 15, 1996, disclosed that some 85,000 medical malpractice cases are filed annually with about 24,000 cases settled annually for approximately $3.8 billion and expenses running about $1.1 billion. Also, the industry reports that there are 15% to 23% annual increases in these sums.

In the field of product liability litigation, direct costs are estimated at $100 billion annually with defense costs of $30 billion. In other fields, such as intellectual property, there are similar sums expended. The Heckman et al U.S. Pat. No. 5,875,431 approaches these problems from the perspective of strategic planning and cost control and management in which the case is developed through process oriented steps rather than the conventional goal oriented steps. Computers interact in this process to produce the desired result.

Wamsley et al, U.S. Pat. No. 6,810,382, is directed to a litigation management system that is computer based and seeks to generate settlement amounts from information gathered during the pursuit of the claim.

U.S. Patent Application 2001/0037204 published Nov. 1, 2001 discloses an on-line dispute resolution method using interactive computer technology to submit settlement offers in monetary ranges which are automatically compared to offers on file to determine an overlap and possible acceptance of the offer by the other party.

Thus, there is a need for a new approach to arbitrating disputes (e.g., medical malpractice cases and the like) that will lessen the litigation load on the courts and more likely result in a reasonable and unbiased decision, especially with regard to the attendant costs and awards, for the opposing parties.

### SUMMARY OF THE PRESENT INVENTION

In one aspect of the present invention, a method is provided for arbitrating a dispute in a specified field of endeavor between opposing parties that include at least one first or aggrieved party and at least one second or accused party (e.g., at least one claimant and at least one provider of services and/or goods). The method comprises providing an arbitration agreement, forming at least one panel having at least three members, and determining liability.

The arbitration agreement sets out the metes and bounds or at least the framework of an arbitration process for arbitrating at least liability claims and preferably also damage claims of the opposing sides. The arbitration process includes at least one panel, which makes liability and, if applicable, damages determinations. The arbitration process can also include two panels, a liability panel for making liability determinations and a damages panel for making damages determinations, if any.

The at least one, panel has at least two opposing members and at least one joint member. The first or aggrieved party selects one of the opposing members, the second or accused party selects another of the opposing members, and the opposing members jointly select the joint member. It may be desirable for the panel to include more than three members such as, for example, when more than one expertise is necessary to decide liability and/or damages. In such a case, each of the opposing parties may choose the same number of the necessary experts, which in turn would jointly choose at least one joint member and preferably the same number of joint members as each party's opposing members.

Liability, and if applicable damages, is determined with evidence presented to the at least one panel. At least part of the evidence is presented by one or more of the opposing parties and/or by a third party. The at least one panel renders a decision as to at least liability. A decision of no liability on the part of the second or accused party terminates the arbitration process and, preferably, also terminates the dispute. The agreement can be written so that the dispute is terminated without prejudice or, preferably, with prejudice.

The at least one first or aggrieved party can be at least one claimant and the at least one second or accused party can be at least one provider of a service, goods or both. The specified field of endeavor can be the healthcare field. The claimant can be at least one of a medical patient and a parent, guardian or relative of the patient. The provider can be at least one of a medical malpractice insurer and a healthcare provider such as, for example, a medical doctor (e.g., a psychologist, psychiatrist, physician, surgeon (e.g., plastic surgeon, heart surgeon, brain surgeon, etc.), internist, midwife, acupuncturist, therapist (e.g., physical therapist, occupational therapist, etc.), nurse, etc. Each of the at least three members can be an expert in the healthcare field.

The specified field of endeavor can be the healthcare field, the claimant can be at least one of a medical patient and a parent, guardian or relative of the patient, the provider can be at least one of a medical malpractice insurer and a healthcare organization such as, for example, a hospital, clinic, HMO, etc., and each of the at least three members can be an expert in the healthcare field. In particular, each of the at least three members can be an expert in the field of the healthcare organization (e.g., an expert in the field of hospital operations, clinic operations, HMO procedures, etc.).

The first party or claimant can be a product consumer (i.e., a person or persons who directly or indirectly purchasers the product), the second party or provider can be at least one of a manufacturer, distributor, wholesaler, retailer and consumer seller (i.e., a person or persons who previously purchased the product and then resold the product to another person or entity) or other seller or reseller of the product, and each of the at least three members can be an expert in the manufacturing, design and/or failure analysis of the product or pertinent component(s) of the product. As used herein, pertinent component(s) of a product refers to any components, features and/or other aspects of the product that have a bearing on, or are, the cause of the dispute being arbitrated.

The present method can further comprise determining damages by evidence on damages being presented to the panel and the panel rendering a decision as to damages. The evidence can be provided by either or both opposing parties.

The forming of at least one panel can comprise forming a first or liability panel for making liability determinations and forming a second or damages panel for making damages determinations.

In one possible embodiment, the at least one panel has at least five members comprising at least four opposing members and at least one joint member. The first or aggrieved party selects two of the opposing members, the second or accused party selects two additional opposing members, and the opposing members jointly select the joint member. Alternatively, the at least one panel can have at least six members comprising the four opposing members and two joint members, with the opposing members jointly selecting the two joint members. These embodiments may be particularly useful when two or more experts in the field of endeavor are necessary, or at least preferred, in determining liability, or two or more fields of endeavor are involved in the dispute.

The present method can further comprise electing a chairman of the at least one panel to determine the presence or absence of liability, with the chairman being elected by the at least three members of the panel. The chairman of the at least one panel is preferably one of the at least three members, but a person who is not a member of the panel may also be chosen.

Under one embodiment of the arbitration agreement, the first or aggrieved party agrees to indemnify and/or defend the accused party against all other potential claimants that may have a cause of action based on the aggrieved party's injuries and that refuse arbitration. For example, such a provision in the arbitration agreement can be used when the specified field of endeavor is the healthcare field, the aggrieved party is at least one of a medical patient and a parent, guardian or relative of the patient, the accused party is at least one of a medical malpractice insurer and a healthcare provider, and each of the at least three members is an expert in the healthcare field.

In another aspect of the present invention, a document is provided that is in the form of an agreement having printed thereon the metes and bounds, or at least the framework, of a method of arbitration according to the principles of the present invention. This document can be an agreement executed by at least one aggrieved party and at least one accused party.

The objectives of this invention can include, without limitation, one or more of the following:

a) Quantify all parties to include the patient and all resulting claimants—e.g., spouse, parents, children, etc., as the first or aggrieved party and the patient's physician, medical group, their respective employees and all vicariously liable parties as the second or accused party.

b) Provide an architecture for the parties to use when there is an injury or death arising out of medical negligence that provides a forum for the parties to resolve all issues in a timely and cost effective manner by qualified experts who serve as arbitrators in a two-step arbitration process—e.g., liability panel decided liability and, if liability, the damage panel decides damages.

c) The patient and the patient's physician are empowered to select the arbitrators to serve under the liability and damage panels. Once these qualified experts are selected, the parties are at arms length from the issues.

d) Regardless of the number of claimants or medical providers, the patient chooses an arbitrator for all claimants and the patient's physician chooses an arbitrator for all medical providers.

e) All liability and damage claims arising out of the medical negligence include the patient, estate, spouse, children, parents and all other claims.

f) The arbitrators under the liability panel are qualified physicians actively practicing medicine in the medical endeavor in question with hands-on experience with the medical issues between the parties.

g) The arbitrators under the damage panel are experts in their own right when addressing damages.

h) The chief arbitrator under the liability and damage panels is a qualified physician with first-hand experience with injured patients and their families.

i) The majority decision of the liability panel is final.

j) The majority decision of the damage panel is final.

k) Promote autonomy through a liability panel that is not dependant on “professional” medical experts when addressing medical issues since they themselves are already qualified in the field of endeavor that is the subject of the current dispute between the parties.

l) Eliminate the cost of hiring medical experts who make their living testifying as experts in medical malpractice cases.

m) Promote closure and finality by encouraging the patient and all resulting claimants to participate in the subject arbitration forum; otherwise, the patient defends and indemnifies the patient's physician against each claim brought by each non-party outside the arbitration agreement.

n) Mandatory remedial education and training for the patient's physician as preventive measure for future patient care when appropriate.

o) Encourage settlement by giving patient's physician option to admit liability without any finding of liability on the physician's record.

p) Chief arbitrator may retain retired court judge to decide evidentiary matters, if necessary.

q) To promote closure and finality the liability panel's decision includes all vicarious liability claims arising out of the patient's physician's medical negligence.

r) A balance between the parties in an imperfect system that limits non-economic damages in the aggregate to $250,000.00 regardless of the number of claims or claimants.

s) Patient and patient's physician acknowledge that no one can guarantee the final outcome of any treatment since there are always risks that can lead to serious injury or death even with the best of medical care.

t) Patient, or person signing on patient's behalf, can consult with another physician, an attorney or the state legal bar before signing the arbitration agreement if they deem it necessary.

u) The patient and the patient's physician each give up their respective rights to a trial by judge or jury in consideration for the terms and conditions under the arbitration agreement

v) In the unfortunate event of any claim for medical negligence, the parties would like to (i) keep things as simple as possible; (ii) enhance early resolution of their differences; (iii) avoid lengthy drawn out litigation through the courts and the stress associated with traditional litigation and jury trials; and (iv) minimize all costs, expenses and attorney's fees.

w) Avoid standard medical arbitration agreement that includes: (i) no bifurcation of liability and damages; (ii) liability and damages decided together by a panel of three lawyers; (iii) medical experts needed to explain liability issues to lawyer panel; (iv) the parties and the panel are 100% dependant on testimony from the medical experts; (v) “professional” liability experts make living off plaintiffs and defense; (vi) no remedial education or training for patient's physician as preventive measure for future patient care; (vii) no predetermined mechanism to admit liability for settlement purposes without a finding of liability on the physician's record which, in turn, impedes the settlement of some or all issues—e.g., liability, causation or damages; (viii) no cap on non-economic damages; and (ix) no mechanism to encourage all claimants to arbitrate their respective claims under the same arbitration forum.

x) Provide continuity between the liability and damage panels without direct input from the parties.

While the above described objectives are focused on specific areas of the healthcare field, they are provided for example only. The present invention is not intended to be so limited.

In one embodiment of the instant invention, a two panel arbitration process is disclosed. The liability panel consists of three (3) qualified physicians thereby eliminating the expense of both sides retaining medical experts. If no liability, the parties save the expense of arbitrating damages. If liability is determined, the parties have 90 days to settle. Otherwise, the second arbitration panel, consisting of two (2) lawyers with damage experience and the chief arbitrator under the liability panel, decides damages.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

Certain terms of art are used in this disclosure and denote the following:

“Arbitration” means the parties' waive their rights to trial by judge or jury in court and instead choose arbitrators to decide and enter judgment for or against them on the issues of liability and damages.

“Arbitrator” means a person who sits in judgement during arbitration.

“Claimant” means the patient or anyone with a claim.

“Consideration” means each party is giving up valuable rights or something of value.

“Dispute” means any claim arising out of medical negligence.

“Pre-suit” means the period of time before the filing of a traditional lawsuit in court.

“Notice” means the patient or claimant provides the patient's physician with formal presuit notice of their claim(s) for medical negligence and resulting damages.

“Investigation” and discovery means the parties provide each other presuit discovery required under state law, if any. (e.g., in Florida, the parties would comply with all pre-suit notice, including an affidavit from a medical provider attesting to the medical negligence as a condition precedent to any claim, and pre-suit discovery under the Medical Malpractice Act.)

“Liability arbitration panel” means they decide all liability claims and consists of three qualified physicians who are chosen as follows:

(a) Patient chooses a physician;

(b) Patient's physician chooses a physician;

(c) These two physicians choose the third physician who serves as the chief arbitrator; and

(d) The panel's majority decision is final.

“Damage arbitration panel” means they decide all damages, assuming liability, and consists of three (3) arbitrators who are chosen as follows:

(a) Patient chooses a lawyer expert with damage experience.

(b) Patient's physician chooses a lawyer expert with damage experience;

(c) The third arbitrator under the liability panel serves as the chief arbitrator.

(d) The panel's majority decision is final.

“Consent to liability” means the patient's physician or medical provider agrees to liability for settlement purposes only and this shall not be deemed an admission or finding of liability.

“Aggregate” means the total amount regardless of the number of persons asserting a claim.

“Claim(s)” means: (a) All liability claims arising out of medical negligence, including percentage of fault if joint tortfeasor, vicarious liability, contract, tort, statute or otherwise; and (b) All resulting injury, death and damages to the patient, patient's parents, spouse, children, anyone else or otherwise (outstanding medical bills unrelated to medical negligence are excluded from this agreement).

“Damage(s)” mean all past and future damages under the law including without limitation all:

(a) Non-economic damages for pain and suffering, disability, disfigurement, mental anguish, loss of capacity for the enjoyment of life, loss of consortium (spouse, children, parental or otherwise) or other non-pecuniary losses;

(b) Economic damages for medical expenses, loss of earnings or other pecuniary losses.

“Defend” means you shall be responsible for the payment of all attorney's fees, costs and expenses incurred by the patient's physician in defending against each non-party's claim.

“Indemnify” means you shall be 100% responsible for any award or judgment entered against the patient's physician.

“Medical negligence” means a claim, arising out of the rendering of, or the failure to render, medical care or services.

“Parties” mean the patient, patient's physician and anyone that signs or adopts this agreement.

“Qualified physician” means that the physician at a minimum shall, during the preceding 12 month period before being retained in the matter:

(a) Be board certified by a certifying board;

(b) Have seen a predetermined amount of patients;

(c) Has a predetermined amount of surgical experience as required by a surgeon; and

(d) Be an active member of a predetermined medical association(s).

Patient's physician shall include for purposes of this agreement:

(a) patients physician's name;

(b) physician's medical group, if any;

(c) each of their respective employees.

“You” means the patient and anyone signing the agreement (excluding patient's physician).

“Vicarious liability” means the:

(a) Patient's physician is responsible for a claim against another person or entity; or

(b) Another person or entity is responsible for a claim against the patient's physician.

### BRIEF DESCRIPTION OF THE DRAWINGS

FIG. 1 is a diagram of the prior art arbitration process;

FIG. 2 is a diagram of the arbitration panel selection and process of this invention;

FIG. 3 is a diagram illustrating the primary differences in a standard medical arbitration agreement and the medical arbitration agreement of this invention; and

FIG. 4 is a diagram illustrating the scope of the claims.

### DETAILED DESCRIPTION OF EXEMPLARY EMBODIMENTS

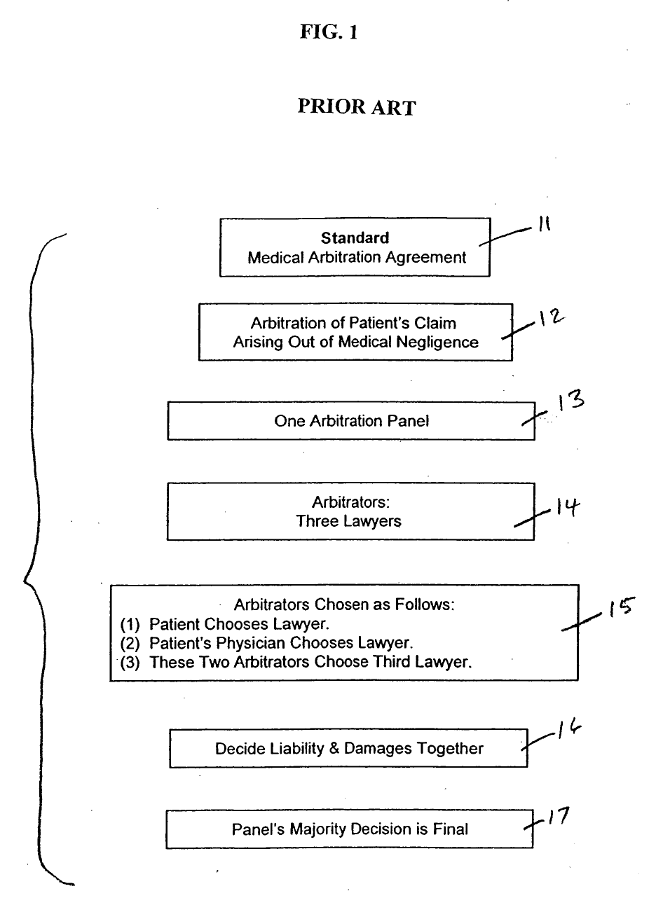

The conventional arbitration process used in medical malpractice, considered to be known prior art, can be represented by the diagram in FIG. 1. To begin the process, as illustrated in block 11, the parties must sign a medical arbitration agreement. The parties to a standard medical arbitration agreement are the patient and the doctor accused of negligence, as shown in block 12. Most notable is that there is no requirement that other affected parties, such as spouse, children, parents, employer, and others must sign the agreement. These parties may litigate outside the arbitration agreement since they have not signed it and/or are not bound by it. This partially defeats the savings of time and money attributed to the process. Further, the affected parties must participate in any outside proceedings involving them.

The arbitration panel shown in block 13 typically consists of professional liability experts who are almost always lawyers, illustrated in block 14. The experts are selected as shown in block 15. Normally, each party elects an expert. These two arbitrators agree on the selection of a third arbitrator and they make up the panel.

The three arbitrators hear all the evidence proffered by both sides, including expert medical witnesses and any others having information or opinions concerning the case. The arbitrators then decide both the liability questions and the amount of damages, as shown in block 16. The decision is by majority and is final, as shown in block 17.

The prior art process utilizes arbitrators drawn from a pool of qualified attorneys who garner substantial fees for their services. These arbitrators must rely on expert witnesses to fully understand the medical procedures, problems, risks and potential medical outcomes. Each side of the arbitration has their own set of medical experts presenting medical testimony designed to result in a decision favorable to their side.

The non-medical panel is then left to figure out conflicting scenarios to arrive at a justifiable decision. This process inherently provides a basis for determining liability since one set of medical experts are testifying to the existence of negligence by the accused doctor.

Since the prior art panels decide both liability and damages, there is the possibility that the damages are so great in life-time care, disfigurement, rehabilitation and pain and suffering that the award of damages drives the finding of liability because some monetary help to the patient will be necessary.

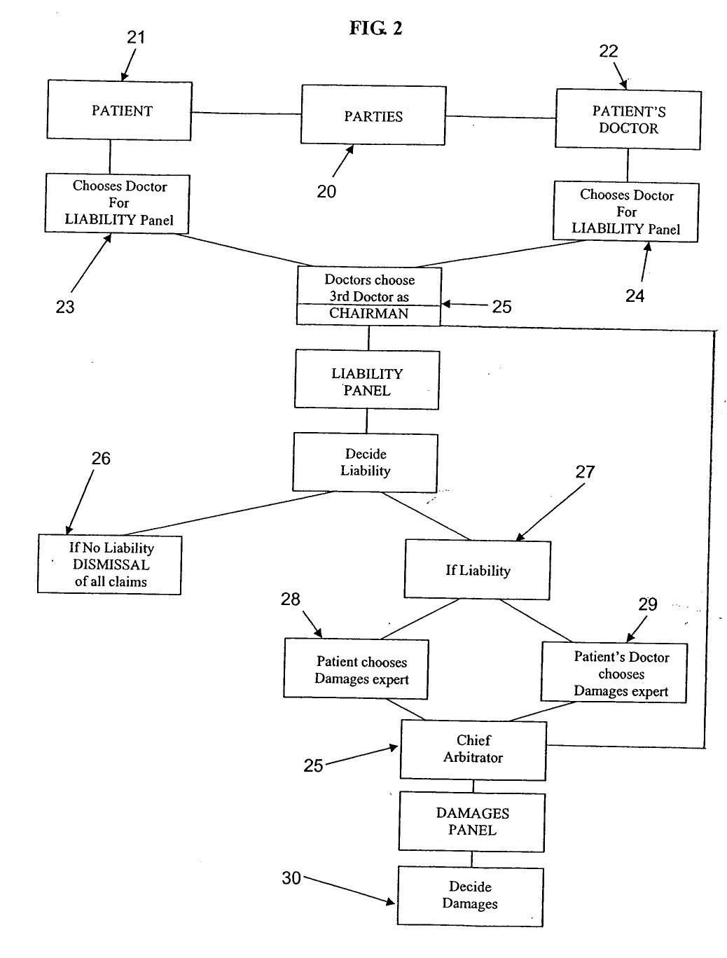

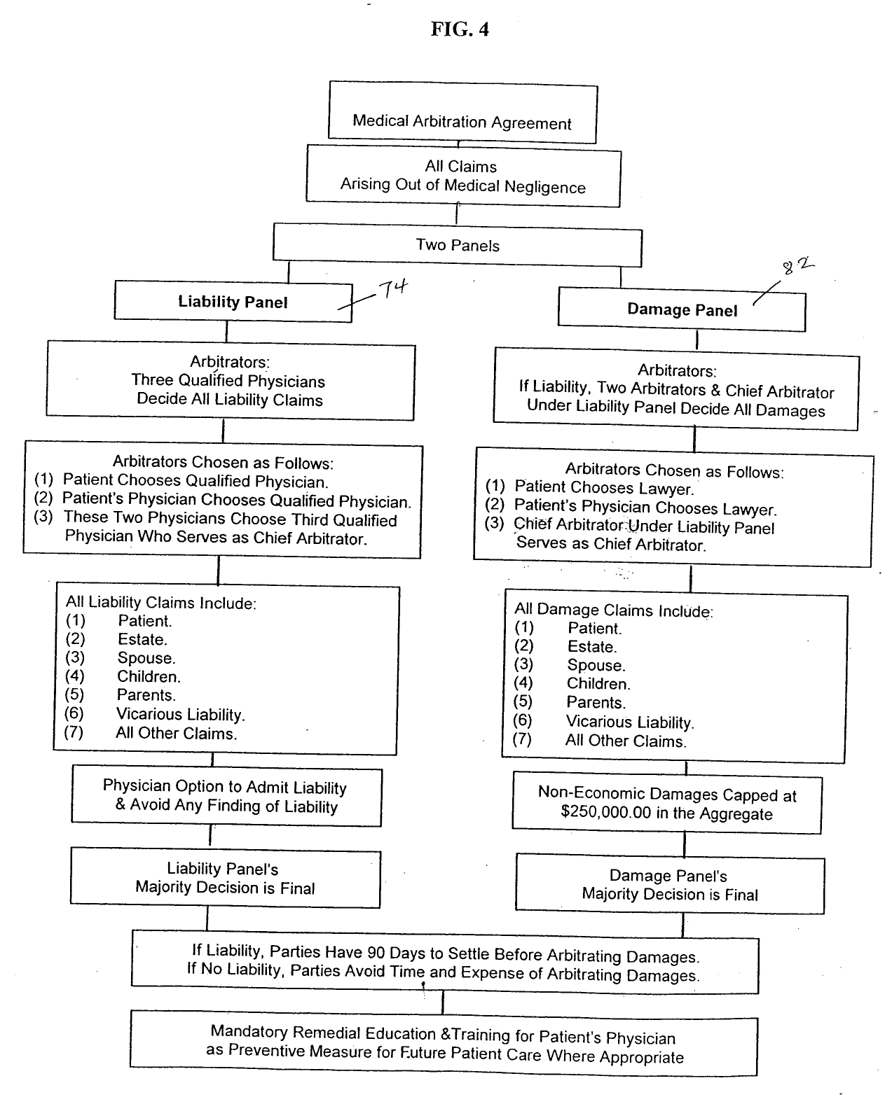

Now referring to FIG. 2, illustrated is the instant invention which employs a selection of the panels with a two step process. The parties 20 are represented as the patient 21 and the patient's physician or doctor 22 however, in the preferred process according to the present invention, the parties include all those who have an interest in the controversy, as shown in FIG. 4 and Table 2, below. The medical arbitration agreement signed by the patient provides indemnification and defense of the accused patient's physician against all claimants who refuse to sign or otherwise be bound by the agreement.

The first step in the process is to determine the presence or absence of negligence or malpractice. A liability panel of three arbitrators is established by the parties. The patient selects a qualified physician or doctor 23 for the panel. The accused patient's physician or organization selects a qualified physician or doctor 24 to be on the panel. These two qualified physicians agree on the selection of the third qualified physician for the panel. This third qualified physician, preferably, serves as chairman 25 on the liability panel.

This medical panel will hear all the evidence regarding the cause of the claim. The content of this hearing would be substantially different from the prior art hearings since the members would be intimately aware of the medical issues, condition of the patient, standards of care, the skill required for the medical procedure, and the likely outcomes. Therefore, the medical presentation of each of the parties would be evaluated by qualified physicians rather than lawyers who must depend and rely on expert witnesses who generally make their living testifying in medical malpractice cases. The outcome of the liability phase would be based on the arbitrator's personal knowledge and years of hands-on experience rather than a panel of lawyers who are forced to rely on the medical experts presented by both sides.

The liability panel could find that there was no liability on the part of the accused patient's physician. In that case the cause would be dismissed 26 or concluded without further proceedings. When deciding liability, the standard of review is two fold. First, the panel must decide whether the accused patient's physician fell below the standard of care. If the answer is no, the panel need not address legal cause. If the answer is yes, then the panel must decide whether this was the legal cause of the patient's claimed injuries or death. For example, the negligence, i.e., below the standard of care, is relevant only if it caused or contributed to the patient's claimed injuries or death. As a result, the liability panel would decide the medical standard in conjunction with the legal standard or causation.

If the panel of three doctors concludes that there was liability 27 on the part of the accused, either the first panel would also decide the issue of damage or, preferably, a second panel is constituted. With the second panel, the patient would pick an expert 28, usually a lawyer, in the field of damage awards. The accused doctor would pick a damages expert 29. These two experts would again choose a third expert on damages, who would be the chairman 25 of the damages panel, in order to make up the damage panel. Alternatively, instead of a third damages expert being chosen, the chairman 25 of the liability panel can serve as a chief arbitrator 25′, in order to make up the damages panel.

These three individuals would hear evidence as to the damages to be awarded to the patient. Constituting a second panel to resolve the damages issues, helps separate the damages from the cause of the injury. In this way, the award may be more directly related to the needs and compensation of the injured rather than the sensationalism of the negligence. Ultimately, the panel would decide whether to award damages 30 and, if so, how much to award.

The instant process can have a much broader scope than the prior art arbitration proceedings when the arbitration agreement represents all the claimants and affected entities on each side of the controversy. This can reduce the collateral lawsuits and appeals that may arise out of the arbitration award. In this regard the aggrieved patient agrees to indemnify and/or defend the accused patient's physician against all other claimants that may have a cause of action based on the patient's injuries (e.g., the patient's spouse, children, parents, guardian, etc.) and that refuse arbitration.

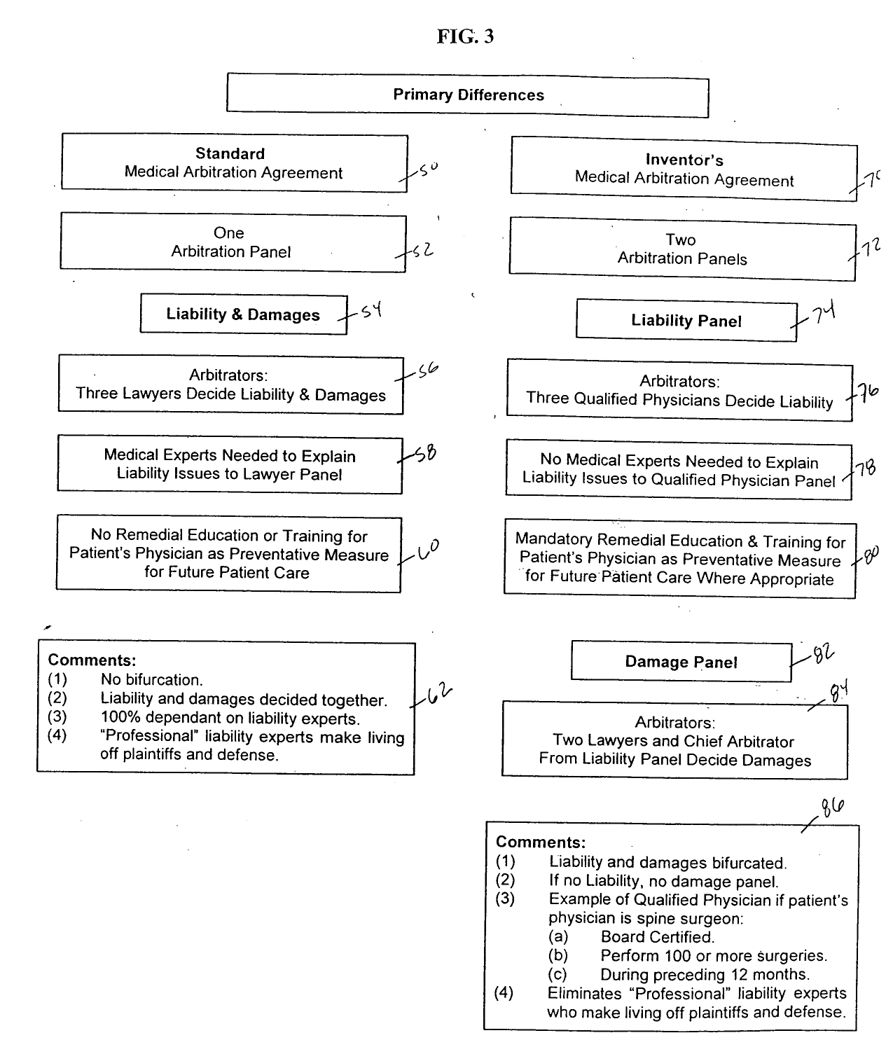

FIG. 3 illustrates the primary differences between a standard medical arbitration agreement 50 and an exemplary medical arbitration agreement of this invention. The standard medical arbitration agreement employs a single arbitration panel 52 to decide liability and damages 54. The arbitrators are typically three lawyers 56 requiring medical experts to explain the technical issues to the lawyers 58. The standard medical arbitration includes no remedial education or training for the patient's physician as preventive measure for future patient care 60. The disadvantages of the standard medical arbitration can include one or more of, but are not necessarily limited to, no bifurcation, liability and damages are decided together, and the process is completely dependant on liability experts who typically make their living off the process 62.

One exemplary medical arbitration agreement 70, according to the present invention, can employ two arbitration panels 72, the first panel decides liability 74. The arbitrators are three qualified physicians 76 eliminating the need for additional medical experts 78 to explain the technical issues. The exemplary medical arbitration can include mandatory remedial education or training for the patient's physician as preventive measure for future patient care 80. A separate panel 82 can consist of two lawyers and a chief arbitrator 84 from the liability panel to decide damages. The advantages of such a medical arbitration can include one or more of, but are not limited to, a process that can employ bifurcation of liability and damages, a process that is not dependent on liability experts who typically make their living off the process 86, and a process that is more likely to result in a reasonable and unbiased decision for the opposing parties.

The following tables provide an illustrative example of differences between claimants when a patient enters into a standard medical arbitration agreement compared to an exemplary medical arbitration agreement according to the instant invention.

What is claimed is:

1. A method of arbitrating a dispute in a specified field of endeavor between opposing parties that include at least one aggrieved party and at least one accused party, said method comprising:
a) providing an arbitration agreement setting out at least the framework of an arbitration process for arbitrating at least liability claims, and optionally damage claims, of the opposing sides;
b) forming a panel having at least three members, with two opposing members and at least one joint member, the aggrieved party selecting one of the opposing members, the accused party selecting another of the opposing members, and the opposing members jointly selecting the joint member; and
c) determining liability, with evidence on liability being presented to the panel, and the panel rendering a decision as to liability,
wherein a decision of no liability by the accused party terminates said arbitration process.

2. The method according to claim 1, wherein the at least one aggrieved party is at least one claimant and the at least one accused party is at least one provider of a service, goods or both.

3. The method according to claim 2, wherein the specified field of endeavor is the healthcare field, the claimant is at least one of a medical patient and a parent, guardian or relative of the patient, the provider is at least one of a medical malpractice insurer and a healthcare provider, and each of the at least three members is an expert in the healthcare field.

4. The method according to claim 3, wherein each of the at least three members is an expert in the field of the healthcare provider.

5. The method according to claim 2, wherein the specified field of endeavor is the healthcare field, the claimant is at least one of a medical patient and a parent, guardian or relative of the patient, the provider is at least one of a medical malpractice insurer and a healthcare organization, and each of the at least three members is an expert in the healthcare field.

6. The method according to claim 5, wherein each of the at least three members is an expert in the field of the healthcare organization.

7. The method according to claim 2, wherein the claimant is a product consumer, the provider is a seller or reseller of the product, and each of the at least three members is an expert in the product or pertinent component(s) of the product.

8. The method according to claim 7, wherein each of the at least three members is an expert in the failure analysis of the product or pertinent component(s) of the product.

9. The method according to claim 1, wherein the arbitration agreement being provided sets out the metes and bounds of the arbitration process.

10. The method according to claim 1 further comprising determining damages by evidence on damages being presented to the panel and the panel rendering a decision as to damages.

11. The method according to claim 1, wherein said forming a panel comprises forming a liability panel for making liability determinations and a damages panel for making damages determinations.

12. The method according to claim 1, wherein the panel has at least five members comprising four opposing members and at least one joint member, with the aggrieved party selecting two of the opposing members, the accused party selecting two additional opposing members, and the opposing members jointly selecting the joint member.

13. The method according to claim 12, wherein the panel has at least six members comprising the four opposing members and two joint members, with the opposing members jointly selecting the two joint members.

14. The method according to claim 1 further comprising electing a chairman of the panel to determine the presence or absence of liability, the chairman being elected by the at least three members of the panel.

15. The method according to claim 14, wherein the chairman of the panel is one of the at least three members.

16. The method according to claim 1, wherein at least part of the evidence being presented to the panel during said determining liability is presented by one or more of the opposing parties.

17. The method according to claim 1, wherein a decision of no liability by either opposing party also terminates the dispute with prejudice.

18. The method according to claim 1, wherein under the arbitration agreement, the aggrieved party agrees to indemnify and/or defend the accused party against all other claimants that may have a cause of action based on the aggrieved party's injuries and that refuse arbitration.

19. The method according to claim 1, wherein the specified field of endeavor is the healthcare field, the aggrieved party is at least one of a medical patient and a parent, guardian or relative of the patient, the accused party is at least one of a medical malpractice insurer and a healthcare provider, each of the at least three members is an expert in the healthcare field, and the aggrieved party agrees to indemnify and/or defend the accused party against all other aggrieved parties that refuse arbitration.

20. A document in the form of an agreement having printed thereon at least the framework of the method of arbitration according to claim 1.

21. A method of arbitrating a dispute in a specified field of endeavor between opposing parties that include at least one aggrieved party and at least one accused party, said method comprising:
a) providing an arbitration agreement setting out at least the framework of an arbitration process for arbitrating at least liability claims, and optionally damage claims, of the opposing sides;
b) forming a liability panel having at least three members, with two opposing members and at least one joint member, the aggrieved party selecting one of the opposing members, the accused party selecting another of the opposing members, and the opposing members jointly selecting the joint member;
c) determining liability, with evidence on liability being presented to the panel, and the panel rendering a decision as to liability, wherein a decision of accused party liability results in the formation of a damages panel, wherein a decision of no liability by the accused party terminates said arbitration process;
d) forming a damages panel having at least three members, with two opposing members and at least one joint member, the aggrieved party selecting one of the opposing members, the accused party selecting another of the opposing members, and the opposing members jointly selecting the joint member, wherein said damages panel determines restitution for said aggrieved party;
whereby said determination of said accused parties liability is separated from said aggrieved parties restitution determination.

22. The method according to claim 21, wherein the at least one aggrieved party is at least one claimant and the at least one accused party is at least one provider of a service, goods or both.

23. The method according to claim 21, wherein the specified field of endeavor is the healthcare field, the claimant is at least one of a medical patient and a parent, guardian or relative of the patient, the provider is at least one of a medical malpractice insurer and a healthcare provider, and each of the at least three members is an expert in the healthcare field.
